(19) United States
(12) Patent Application Publication
(10) Pub. No.: US 2025/0162344 A1
(43) Pub. Date: May 22, 2025

(54) Erasable Drawing Notebook

(71) Applicant: Dongwei Liu, Shenzhen (CN)

(72) Inventor: Dongwei Liu, Shenzhen (CN)

(21) Appl. No.: 19/027,683

(22) Filed: Jan. 17, 2025

(51) Int. Cl. B43L 1/00; B42B 5/12

(52) U.S. Cl. CPC B43L 1/00; B42B 5/12

(57) ABSTRACT

The present invention applicable to the technical field of stationery provides an erasable drawing notebook, which includes a cover, a back cover and connection rings. At least one middle page is arranged between the cover and the back cover. The cover, the back cover and the middle page are binded in series via the connection rings. An erasable writing area is arranged on the middle page, and a first storage bag is arranged on the cover surface. The erasable drawing notebook can be repeatedly used for activities such as writing, drawing, and painting, etc. Besides, users can store items in the storage bags to avoid loss of items.

### CROSS-REFERENCE TO RELATED APPLICATIONS

The present invention claims the benefit of Chinese Patent Application No. 2025201103901 filed on Jan. 17, 2025, the contents of which are hereby incorporated by reference.

### TECHNICAL FIELD

The present invention belongs to the technical field of stationery, particularly relates to an erasable drawing notebook.

### TECHNICAL BACKGROUND

During the early childhood enlightenment stage, young children often lack precise control ability when painting. Young children often make mistakes or are dissatisfied with their own paintings. Therefore, they may not dare to try boldly for fear of making mistakes. It reduces their enthusiasm and initiative in painting and makes the painting process become restrained and unpleasant.

In addition, young children are in a critical period of developing painting skills and imagination. They need to improve their painting skills and creativity through continuous attempts and exploration. In the painting process, they need to freely combine and adjust different elements, colors and compositions to explore new drawing methods and forms of expression. However, if young children make mistakes on the conventional drawing notebooks, they might have to redo all the works.

### INVENTION CONTENT

In order to overcome the defects of the existing technology, the present invention provides an erasable drawing notebook, which can be repeatedly used for activities such as writing, drawing, and painting, etc. Besides, users can store items in the storage bags to avoid loss.

The technical scheme adopted by the present invention for solving the technical problems is as follows:

An erasable drawing notebook includes a cover, a back cover and connection rings. At least one middle page is arranged between the cover and the back cover. The cover, the back cover and the middle page are binded in series via the connection rings. An erasable writing area is arranged on the middle page, and at least one first storage bag is arranged on the cover surface.

Further, the cover and the first storage bag are both made of flexible materials. A plurality of push balls are arranged on the surfaces of the cover and the first storage bag.

Further, one erasable writing area is respectively arranged on the two sides of the middle page.

Further, the back cover includes a first surface and a second surface; the second surface is bent toward the direction of the connection rings. One erasable writing area is respectively arranged on the first surface and the second surface.

Further, the erasable drawing notebook also includes a second storage bag binded to the connection rings.

Further, the second storage bag is binded to the connection rings via a hanging strap.

Further, the cover and the back cover are closed through a magnetic buckle.

Further, the cover is provided with a first magnetic piece. The back cover is provided with a magnetic buckle, and a second magnetic piece is arranged on the end of the magnetic buckle.

Further, a storage pocket is arranged on one side of the back cover away from the middle page.

Further, the storage pocket made of transparent material is of an open structure.

The beneficial effects of the present invention:

The present invention provides an erasable drawing notebook, which can be repeatedly used for activities such as writing, drawing, painting, etc. Besides, users can store items in the storage bags to avoid loss.

### DESCRIPTION OF FIGURES

FIG. 1 is a schematic view of an erasable drawing notebook in Embodiment I of the present invention;

FIG. 2 is a schematic view of the erasable drawing notebook in an open state in Embodiment I of the present invention;

FIG. 3 is a schematic view of the back cover of the erasable drawing notebook in Embodiment I of the present invention;

FIG. 4 is a schematic view of an erasable drawing notebook in Embodiment II of the present invention;

FIG. 5 is a schematic view of an erasable drawing notebook in Embodiment III of the present invention;

FIG. 6 is a schematic view of another state of the erasable drawing notebook in Embodiment III of the present invention;

FIG. 7 is a schematic view of an erasable drawing notebook in Embodiment IV of the present invention;

### DESCRIPTION OF MARKS IN FIGURES

1—cover; 2—middle page; 3—back cover; 31—first surface; 32—second surface; 4—connection ring; 5—first storage bag; 51—first zipper; 6—push ball; 7—second storage bag; 71—second zipper; 72—hanging strap; 8—first magnetic piece; 81—magnetic buckle; 82—second magnetic piece; 9—storage pocket.

### DETAILED DESCRIPTION OF THE EMBODIMENTS

The present embodiment only shows an explanation of the present invention and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

### Embodiment I

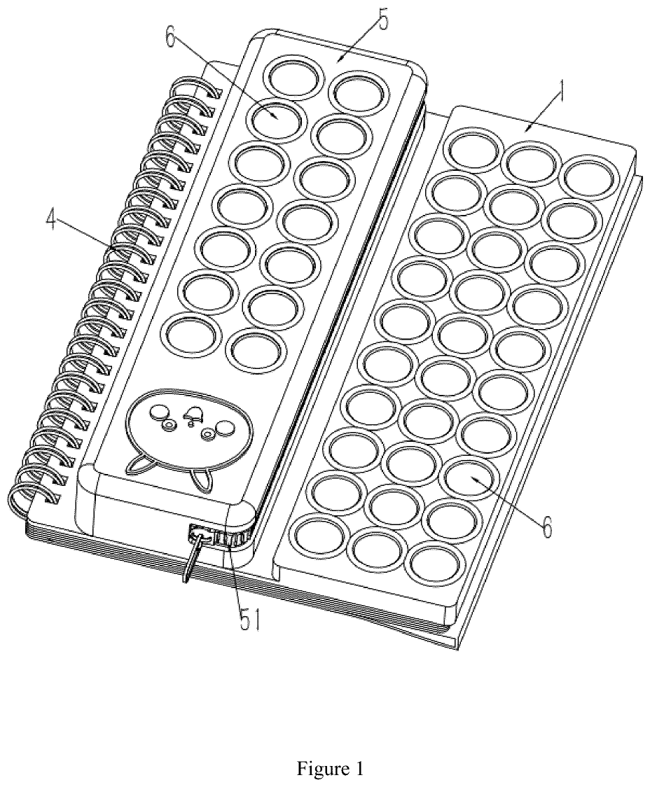

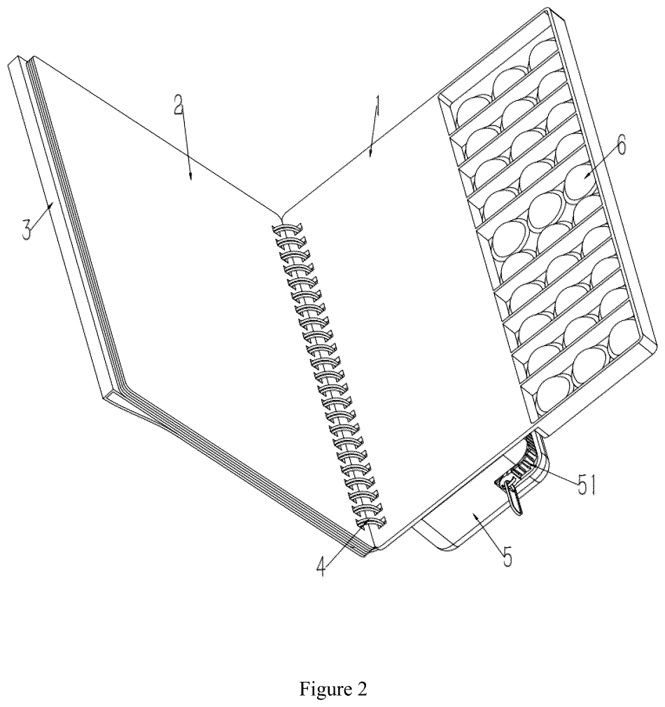

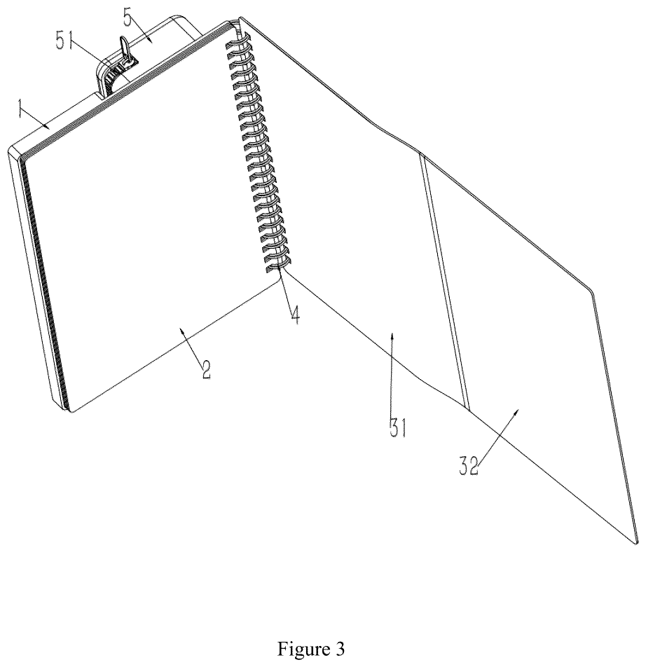

Referring to FIGS. 1 to 3, this embodiment provides an erasable drawing notebook, including a cover 1, a back cover 3 and connection rings 4. At least one middle page 2 is arranged between the cover 1 and the back cover 3. The cover 1, the back cover 3 and the middle page 2 are binded in series via the connection rings 4. An erasable writing area is arranged on the middle page 2, and a first storage bag 5 is arranged on the surface of the cover 1.

By arranging the connection rings 4, the cover 1, the back cover 3 and the middle page 2 can be smoothly turned over around the connection rings, which is convenient for users.

Preferably, the surface of the writing erasable area is provided with a certain texture. When users write in the writing erasable area with chalk, grease pen or crayon, the written content will be retained in the writing erasable area by the texture. This means that users can devote themselves to the creation when creating, as they do not have to worry that the written content will be easily lost due to the shaking of the papers or slight friction.

It should be noted that the surface of the erasable writing area is coated with a waterproof polymer. Users can use a wet wipe to erase the written content after writing, so as to provide a clean and tidy space for the next creation.

By arranging the first storage bag 5 on the surface of the cover 1, users can store the writing tools in the first storage bag 5 after arranging the writing tools in a unified manner, so as to reduce the risk of the loss of writing tools.

Preferably, the cover 1 and the first storage bag 5 are both made of flexible materials. A plurality of push balls 6 are arranged on the surfaces of the cover 1 and the first storage bag 5.

In one embodiment, the plurality of push balls 6 are arranged in N rows*M columns, and N and M are integers. It should be noted that N and M can be different numbers or the same numbers.

Specifically, the cover 1, the first storage bag 5 and the plurality of push balls 6 are all made of silicone materials, which can return to their original shapes after being squeezed. Users can achieve the purpose of decompression through the pressing the push balls 6. At the same time, the interesting of the erasable drawing notebook of this embodiment is increased.

It can be seen from this that the erasable drawing notebook provided in this embodiment is not only suitable for young children, but also suitable for adults under pressure.

In actual applications, an area on the cover where the push balls are set can be customized. For example, a silicone embedding area can be set in the area to replace the push balls, and users can embed an electronic calculator, electronic pet, or children's educational toy product of suitable size in the silicone embedding area. It should be noted that the size of the silicone embedding area should be smaller than the size of the embedded product. The elastic stretchable recovery characteristics of silicone can be used to tightly embed the product in the silicone embedding area, which can meet the diversified needs of users and improve the market competitiveness of the product.

Preferably, the first storage bag 5 is provided with a first opening (not shown in Figures) and a first zipper 51. Users can open or close the first opening through the first zipper 51 to store or keep items in the first storage bag 5.

The design of the first zipper 51 not only ensures the sealing of the first storage bag 5 to prevent items from accidentally falling, but also facilitates users' operations as users only needs to pull it lightly to store or take out items.

Preferably, one erasable writing area is respectively arranged on the two sides of the middle page 2 to provide more writing space for users.

Further, the middle page 2 can be provided with multiple pages At least one of the middle pages 2 is designed as a transparent copying board, which makes it more convenient for users whether copying classic paintings or creating works based on photos, and meets more painting needs of users.

Preferably, the back cover 3 includes a first surface 31 and a second surface 32; the second surface is bent toward the connection rings 4. One erasable writing area is respectively arranged on the first surface 31 and the second surface 32. Users can unfold the second surface 32 so that the first surface 31 and the second surface 32 present a plane, which make the originally limited writing spaces expand, so that users can draw some larger-sized patterns.

### Embodiment II

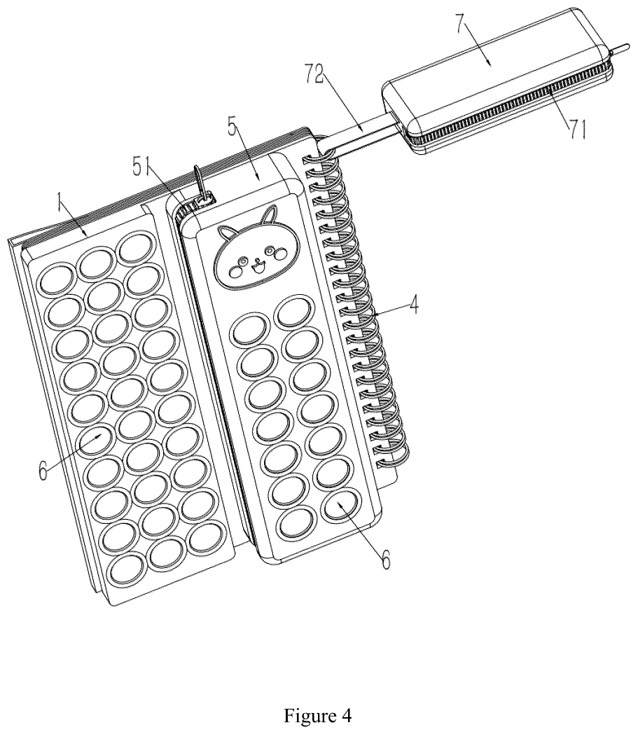

Referring to FIG. 4, the difference between Embodiment II and Embodiment I is that the erasable drawing notebook also includes a second storage bag 7 binded to the connection rings 4.

The design concept of the second storage bag 7 is similar to that of the first storage bag 5, but it provides more storage options for users. For example, users can put some commonly used drawing auxiliary tools, such as erasers, pencil sharpeners, etc., in the second storage bag 7 so as to facilitate their access of the drawing auxiliary tools.

Specifically, the second storage bag 7 binded to the connection rings 4 via a hanging strap 72 is provided with a second opening (not shown in Figures) and a second zipper 71. Users can open or close the second opening via the second zipper 71 to store or keep items in the second storage bag 7.

Further, the position of the second storage bag 7 can be adjusted according to rotation of the connection rings 4, which is convenient for users to access the items in the second storage bag 7.

The remaining features and advantages of embodiment II are the same as those of embodiment I.

### Embodiment III

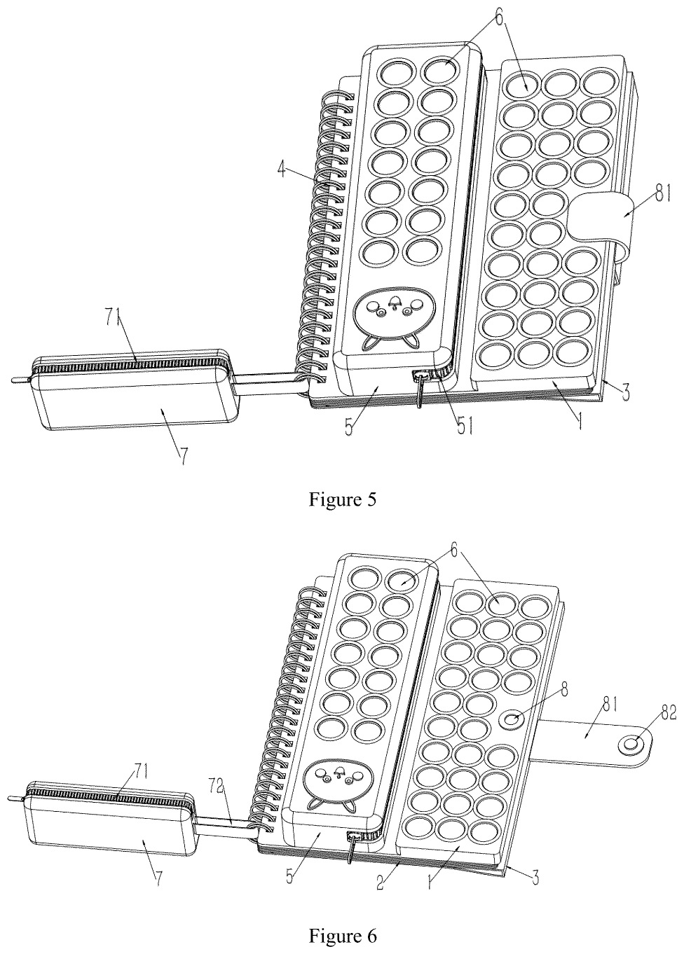

Referring to FIGS. 5 to 6, the difference between Embodiment III and Embodiment II is that the cover 1 and the back cover 3 are closed through a magnetic buckle 81.

The design of the magnetic buckle 81 makes the erasable drawing notebook of this embodiment very convenient to open and close. With the design of the magnetic buckle 81, users can tightly fix the cover 1 and the back cover 3 only by bringing the cover 1 and the back cover 3 together. The erasable drawing notebook is not open easily and accidentally even on a bumpy road or in a bag. In addition, the magnetic buckle 81 is wear-resistant, corrosion-resistant and not easy to be damaged, so that it can maintain good magnetic attraction performance for a long time.

Specifically, the cover 1 is provided with a first magnetic piece 8. The back cover 3 is provided with a magnetic buckle 81, and a second magnetic piece 82 is arranged on the end of the magnetic buckle 81. By adjusting the position of the magnetic buckle 81, the first magnetic piece 8 and the second magnetic piece 82 can be magnetically fixed or detached, so as to fix or open the erasable drawing notebook.

In actual applications, structures such as rope buckles, snap buckles or silicone nail buckles can also be selected to connect and fix the cover 1 and the back cover 3.

The remaining features and advantages of Embodiment III are the same as those of Embodiment II.

### Embodiment IV

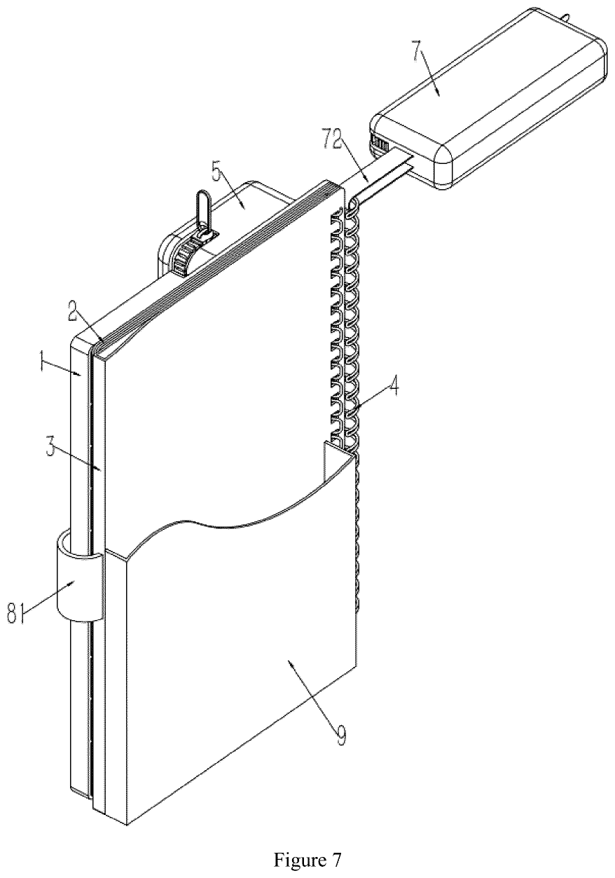

Referring to FIG. 7, the difference between Embodiment IV and Embodiment III is that a storage pocket 9 used to store some daily necessities is arranged on one side of the back cover away from the middle page.

Specifically, the storage pocket 9 made of transparent material is of an open structure, which can facilitate users to observe the items placed in the storage pocket 9. Whether it is keys, cards, or some snacks, users can see the items in the storage pocket 9 at a glance, which is convenient for users access the items quickly.

In another embodiment, the storage pocket 9 is configured as a mesh structure, which can also facilitate users to observe the items in the storage pocket 9.

The remaining features and advantages of Embodiment IV are the same as those of Embodiment III.

It could be understood that under the guidance of the above embodiments, those skilled in the filed can combine various implementation methods in the above embodiments to obtain technical solutions of multiple implementation methods.

The above description is only a preferred embodiment of the present invention and is not to limit the present invention. Any modifications, equivalent substitutions and improvements made within the spirit and principles of the present invention should be included in the protection scope of the present invention.

We claim:

1. An erasable drawing notebook, comprises a cover, a back cover and connection rings, wherein at least one middle page is arranged between the cover and the back cover; the cover, the back cover and the middle page are binded in series via the connection rings; an erasable writing area is arranged on the middle page, and a first storage bag is arranged on the cover surface.

2. The erasable drawing notebook according to claim 1, wherein the cover and the first storage bag are both made of flexible materials; a plurality of push balls are arranged on the surfaces of the cover and the first storage bag.

3. The erasable drawing notebook according to claim 1, wherein one erasable writing area is respectively arranged on two sides of the middle page.

4. The erasable drawing notebook according to claim 1, wherein the back cover comprises a first surface and a second surface; the second surface is bent toward the direction of the connection rings; one erasable writing area is respectively arranged on the first surface and the second surface.

5. The erasable drawing notebook according to claim 1, wherein the erasable drawing notebook also comprises a second storage bag binded to the connection rings.

6. The erasable drawing notebook according to claim 5, wherein the second storage bag is binded to the connection rings via a hanging strap.

7. The erasable drawing notebook according to claim 1, wherein the cover and the back cover are closed through a magnetic buckle.

8. The erasable drawing notebook according to claim 7, wherein the cover is provided with a first magnetic piece; the back cover is provided with a magnetic buckle, and a second magnetic piece is arranged on an end of the magnetic buckle.

9. The erasable drawing notebook according to claim 1, wherein a storage pocket is arranged on one side of the back cover away from the middle page.

10. The erasable drawing notebook according to claim 9, wherein the storage pocket made of transparent material is of an open structure.
